(19) United States
(12) Patent Application Publication
(10) Pub. No.: US 2025/0368256 A1
(43) Pub. Date: Dec. 4, 2025

(54) TRANSMISSION DEVICE FOR A STEERING SYSTEM, STEERING SYSTEM, METHOD FOR MONITORING A TRANSMISSION UNIT, AND COMPUTER PROGRAM PRODUCT

(71) Applicant: HELLA GMBH & CO. KGAA, Lippstadt (DE)

(72) Inventors: Henning Irle, Lippstadt (DE); Christoph Wostmann, Lippstadt (DE)

(21) Appl. No.: 19/226,602

(22) Filed: Jun. 3, 2025

(30) Foreign Application Priority Data
Jun. 4, 2024 (DE) 102024115450.0

(51) Int. Cl. B62D 5/04; B62D 5/00; G02B 6/35

(52) U.S. Cl. CPC B62D 5/0481; B62D 5/001; G02B 6/3504

(57) ABSTRACT

The present invention relates to a transmission device for a steering system. The steering system includes a transmission unit with a rotatable first gear element, which may be driven by a drive. The steering system also includes a rotatable second gear element, which is operatively connected to the first gear element for transmitting the drive movement as a function of a transmission ratio between the first and second gear elements. A monitoring unit is further included for monitoring the transmission unit with a detection means for detecting an actuated rotational position of the transmission unit when transmitting the drive movement within a predefined rotational range. The invention also relates to a steering system, a method, and a computer program product.

### CROSS-REFERENCE TO RELATED APPLICATIONS

The present application claims the benefit of German Patent Application No. 10-2024-115-450.0, filed Jun. 4, 2024, the disclosure of which is incorporated by reference.

### BACKGROUND OF THE INVENTION

The invention relates to a transmission device for a steering system, a steering system, a method for monitoring a transmission unit of a transmission device, and a computer program product.

In vehicles, it is common practice to provide steering systems with electric drives, for example, to implement power steering. In known axis-parallel drives (APA), a control unit often drives a ball screw drive that converts the rotational movement into a translational movement in order to move a steering rod. The steering rod is used to adjust the steering angle of the vehicle's wheels.

In order to electronically detect the steering angle at any time, it is also known to detect the rotational angle of the gear elements involved. For this purpose, the rotational angle may be detected within one revolution, particularly by low-cost sensors. However, since multiple revolutions of the involved gear elements are generally required, the rotational angle may be highly ambiguous for the intended adjustment range. The ambiguity may be reduced or avoided, for example, by using a vernier arrangement. It is known from document WO 2023/174502 A1, for example, that two gear elements are designed in such a way that their diameters are relatively prime in order to enable unambiguous detection of the respective number of revolutions.

However, especially during the operation of belt drives, belt slippage may occur under certain circumstances, for example, as a result of wear, so that the detected number of revolutions may not correspond to the actual number of revolutions. This may result in an unnoticed error when detecting the position of the steering rod, which may affect the operation of the steering system.

### SUMMARY OF THE INVENTION

It is an object of the present invention to at least partially eliminate the above disadvantages known from the prior art. In particular, it is an object of the present invention to improve safety in the operation of a steering system and/or accuracy in the monitoring of a transmission unit in a transmission device for the steering system.

The above object is achieved by a transmission device with the features of the current embodiments, a steering system with the features of the current embodiments, a method with the features of the current embodiments, and a computer program product with the features of the current embodiments. Further features and details of the invention are apparent from the dependent claims, the description and the drawings. Features and details described in connection with the transmission device according to the invention naturally also apply in connection with the steering system according to the invention, the method according to the invention, and/or the computer program product according to the invention, and vice versa, so that mutual reference is or may always be made with respect to the disclosure of the individual aspects of the invention.

According to a first aspect of the invention, a transmission device for a steering system is provided. The transmission device has a transmission unit with a rotatable first gear element, which may be driven by a drive. Furthermore, the transmission unit comprises a rotatable second gear element, which is operatively connected to the first gear element for transmitting a drive movement as a function of a transmission ratio between the first and second gear elements. The transmission device also has a monitoring unit for monitoring the transmission unit with a detection means for detecting a controlled rotational position of the transmission unit when transmitting the drive movement in a predefined rotational range. Furthermore, the transmission device has a detection device for detecting at least one control position of the first and second gear elements for marking a predefined rotational position of the transmission unit within the rotational range, in particular for the control position. The monitoring unit is designed to compare the controlled rotational position with the predefined rotational position when the control position is reached in order to monitor the transmission unit.

The drive movement, which may be transmitted by the transmission unit of the transmission device, may be used, in particular, to drive a steering rod of the steering system. However, it is also conceivable that the transmission device forms a separate sensor unit, which may be arranged for monitoring the drive in the steering system, in particular on the steering rod.

The drive may comprise an actuator, in particular in the form of an electric motor, for moving a steering rod of the steering system. The drive may therefore also be described as a steering drive. The drive may be integrated into the transmission device and/or the steering system.

The first and second gear elements may each have a gear wheel for transmitting the drive movement by means of a mutual gear mesh and/or a pulley for transmitting the drive movement by means of a belt. The transmission ratio may be defined by the number of teeth and/or the diameters of the first and second gear elements. The transmission ratio may be used to define a speed and/or torque of the second gear element as a function of a speed and/or torque of the first gear element.

The detection device and/or the monitoring unit may be integrated into a control unit of the steering system. The control unit may comprise at least one processor and/or microprocessor. Furthermore, the control unit may be at least partially or fully integrated into a central control unit of the vehicle. However, it is also conceivable that the control unit is at least partially or fully integrated into one or more decentralized control units.

The controlled and/or predefined rotational position may comprise or correspond to a number of revolutions, preferably an electrical or mechanical number of revolutions. In particular, the controlled and/or predefined rotational position can be determined on the basis of a sum comprising a product of a number of revolutions with a circular angle of 360°, and a position value of an angle sensor within a range between 0° and 360°. If the drive also comprises, for example, a three-pole electric motor, a sensor may be provided to determine an angular position within a unique range of 120°.

The controlled and predefined rotational positions may also be rotational positions of the first or second gear element. Preferably, the controlled rotational position and the predefined rotational position are each a rotational position of the first gear element. In particular, the controlled rotational position may correspond to the rotational position of the drive and/or be specified by a control unit for controlling the drive, in particular as a target rotational position. The predefined rotational position may mark an index point. In particular, the predefined rotational position may be a rotational position that corresponds to the predefined rotational position in the control position in normal operation of the transmission device, i.e., for example, in fault-free operation without belt slippage. The detection means may comprise an electronic counter for counting a number of revolutions to determine the controlled rotational position. For example, a drive speed of the drive may be detected, and the controlled rotational position may be determined, in particular calculated or defined, using the drive speed. The drive speed may be detected, for example, using a motor control unit of the drive and/or a sensor system. A revolution counter may be adapted to a position sensor for commutating the drive, for example, by using the revolution counter to count the electrical revolutions. It may be possible to calculate a number of mechanical revolutions based on the electrical revolutions to determine the number of revolutions.

The rotational range may be understood as an adjustment and/or measuring range within which the controlled rotational position moves during normal operation and/or intended use of the steering system. In particular, the rotational range may include at least one maximum rotational position of the first gear element, in particular as a function of the direction of rotation. For example, the steering system may have a side stop that limits the movement of the steering rod when the maximum rotational position is reached.

The control position may be understood as a specific position of the first and second gear elements, in particular in relation to each other, which marks the predefined rotational position. Preferably, the first and second gear elements are designed to assume the control position only once, i.e. in particular only at the predefined rotational position, within the rotational range. Thus, the predefined rotational position represents in particular an expected rotational position when the control position is reached. It may be provided that the control position coincides with a zero position of the steering rod for driving the vehicle straight ahead.

When comparing the controlled rotational position and the predefined rotational position, it is possible to check whether the controlled and predefined rotational positions differ. Thus, it has been recognized in the context of the present invention that the control position may represent a comparison value for the detected, controlled rotational position. This, in turn, may be an indicator of a deviation of the controlled rotational position from the intended rotational position. For example, a specific rotational position may be controlled by specifying a motor speed. If the controlled rotational position in the control position matches the predefined rotational position for the control position, it may be assumed that the specific rotational position has been implemented by the transmission unit without errors or within a tolerance. If a deviation is detected, it may be concluded that there is a deviation, e.g. due to a belt slippage. In particular, an index switch may thus be formed by the first and second gear elements in order to correlate a motor position of the drive with the control position, in particular in the form of a dedicated, relative, and single position of the two transmission elements, and thereby to detect a belt slippage and/or enable prediction of the state of use and wear of the transmission unit.

Furthermore, in a transmission device according to the invention, it is conceivable that the first gear element is designed to perform a first rotational position within the rotational range, and the second gear element is designed to perform a second rotational position within the rotational range, the first and second rotational positions being relatively prime. For example, the transmission ratio may be defined by prime numbers, in particular, two or more digits, in the numerator and denominator of the transmission ratio. Furthermore, the number of teeth of the first and second gear elements may be coprime. The coprime rotational positions may be used to ensure that the control position is only reached once or only at predefined positions in the rotational range. In particular, a vernier arrangement may be formed by the first and second gear elements. The transmission ratio based on the vernier principle may ensure that the control position is defined within the rotational range.

Furthermore, in a transmission device according to the invention, it may advantageously be provided that the transmission unit forms a belt drive, wherein the first and second gear elements are each formed by a pulley and/or are connected by a belt. For example, the belt drive may comprise a ball screw drive. Preferably, the first or second gear element may be rotationally fixed to the ball screw nut. The advantage of the belt drive design is that it is robust and has a long service life for use in the vehicle. If, for example, a belt slippage occurs as a result of wear or extreme external forces caused by the situation, in which the belt moves by one or more teeth relative to the first and/or second gear element, the deviation may be detected by comparing the controlled rotational position with the predefined rotational position at the control position. It may be provided that the monitoring unit is designed to output information about the wear of the belt and/or information about a deviation of the controlled rotational position from the predefined rotational position based on the comparison of the controlled rotational position with the predefined rotational position at the control position. For example, the deviation may be used to provide an offset for controlling the steering system, in particular to enable the vehicle to be driven to a workshop.

Furthermore, in a transmission device according to the invention, it may advantageously be provided that the detection device has a signal generating unit for outputting a control signal as a function of a physical interaction of the first and second gear elements in the control position. The physical interaction may trigger the control signal directly or indirectly. For example, the interaction may include an energy transfer between the first and second gear elements, which may be detected by the detection device and/or used to output the control signal. The interaction or the intensity of the interaction may only be present in the control position. The intensity of the interaction may include, for example, a signal strength. The interaction may enable the electronic detection of the control position in a simple manner.

Furthermore, in a transmission device according to the invention, it is conceivable that the interaction of the first and second gear elements in the control position comprises an electrical, electromagnetic, optical and/or sound-based signal line. For example, the interaction may involve transmission of sound waves or radio waves through the first and second gear elements and/or between the first and second gear elements. Furthermore, the interaction may include a current flow and/or a light line. The control signal may be triggered easily via the signal line. Furthermore, triggering of the control signal may be clearly defined in order to recognize the control position. Furthermore, the first and second gear elements may comprise resonant circuits in order to generate one or more resonance frequencies depending on the orientation of the transmission elements. A distinct specific resonance frequency may be achieved in the control position.

Furthermore, in a transmission device according to the invention, it is conceivable that the signal generating unit has a first signal generating element for rotation with the first gear element and a second signal generating element for rotation with the second gear element, wherein the signal generating unit is designed to output the control signal as a function of a position of the first and second signal generating elements relative to one another. Therefore, the first signal generating element is connected to the first gear element in a rotationally fixed manner, and the second signal generating element is connected to the second gear element in a rotationally fixed manner. The first signal generating element may be attached to the first gear element in a positively locking, force-locking, and/or material-bonded manner. The second signal generating element may be attached to the second gear element in a positively locking, force-locking, and/or material-bonded manner. The signal generating unit may be designed so that the first and second signal generating elements trigger and/or specifically amplify the interaction between the first and second gear elements in the control position. This makes it easy to detect the control position.

Furthermore, in a transmission device according to the invention, it is conceivable that the signal generating unit has a signal source and a signal receiver, wherein the signal source and/or the signal receiver are arranged in a fixed position on a housing of the transmission unit, wherein the first signal generating element may be coupled to the signal source and the signal receiver in a coupling position within one revolution of the first gear element and may be decoupled from the signal source and the signal receiver outside the coupling position. The interaction between the first and second gear elements may include a signal line between the signal source and the signal receiver. The housing can at least partially surround the transmission unit and/or support the first transmission element. The fixed arrangement of the signal source and/or the signal receiver on the housing ensures that only integer rotational positions of the first gear element may be considered for the coupling position. This allows the controlled rotational position to be counted in a simple manner. Furthermore, it may be ensured that the first gear element in the control position is in an alignment with the housing specified by the coupling position, so that the first gear element may form a fixed point for comparing the controlled and predefined rotational positions.

Furthermore, in a transmission device according to the invention, it may advantageously be provided that a signal path may be formed by the first and second signal generating elements, which is closed in the control position. In particular, the signal path may be formed by an electrically conductive and/or hollow channel. In particular, the signal path may connect the signal source to the signal receiver when the first gear element is in the coupling position and the first and second gear elements are in the control position. The signal path may therefore be used to ensure that a signal connection between the signal source and the signal receiver exists only in the control position, in order to trigger the control signal. This enables the control position to be detected in a simple and reliable manner.

Preferably, in a transmission device according to the invention, it may be provided that the signal generating unit has a light source for outputting the control signal as an optical signal. The light source may preferably comprise an LED. Preferably, the light source may be designed to output a predefined light spectrum that can be detected by the signal receiver. The signal receiver may preferably comprise a photodiode. It may be provided that the signal generating unit is designed to emit the optical signal as pulsed and/or modulated light. For example, the optical signal may be modulatable by the signal generating unit with a predefined frequency and/or output as a bit sequence and/or be encoded. In particular, the signal may be implemented as a pseudo-random coded signal. This enables the signal to be detected robustly against ambient light.

Preferably, in a transmission device according to the invention, it may be provided that the first and second signal generating elements each comprise at least one optical waveguide for guiding the optical signal, in particular wherein the optical waveguides each have two connection points that may be aligned with one another in the control position for transmitting the optical signal along the optical waveguides. The optical waveguides may comprise, for example, an optical fiber, in particular in the form of a plastic and/or glass fiber. Preferably, an optical system, e.g. in the form of a lens, may be arranged at each of the connection points in order to transmit the optical signal between the optical waveguides in a directed manner. The optical waveguides enable robust transmission of the optical signal.

It is also conceivable in a transmission device according to the invention that a drive motor of the drive is integrated into the transmission device, the drive motor being connected directly, i.e. in particular immediately and/or without loss, to the first gear element in order to rotate the first gear element at a motor speed of the drive motor. Preferably, the drive motor may be a brushless electric motor. Thus, the transmission device can form a drive unit for the steering system. In this case, the transmission device itself may comprise a control unit to control the drive motor or be externally controllable. Due to the direct connection of the drive motor to the first gear element, the controlled rotational position can correspond to the motor speed. The first gear element may be rotationally fixed to a drive shaft of the drive. The motor speed can therefore be detected in a simple manner, e.g. using a motor control unit of the drive and/or a sensor system.

In a transmission device according to the invention, it is also conceivable that the monitoring unit is designed with a memory unit for temporarily storing the controlled rotational position in a de-energized state of the transmission device, in particular of the monitoring unit. The memory unit may comprise an electronic data memory. The intermediate storage may be triggered when the vehicle is switched off and/or when a disconnection from a vehicle battery is detected. For example, the transmission device may comprise an energy storage unit for storing emergency and/or residual energy in order to execute the intermediate storage. This allows the controlled rotational position to be available when the transmission device is restored to a de-energized state.

According to a further aspect of the invention, a steering system for a vehicle is provided. The steering system comprises a transmission device according to the invention.

Thus, a steering system according to the invention has the same advantages as those already described in detail with reference to a transmission device according to the invention. The steering system is preferably a servo system and/or a steer-by-wire system.

According to a further aspect of the invention, a method for monitoring a transmission unit of a transmission device according to the invention is provided. The method comprises, in particular in the form of process steps: detection of a controlled rotational position of the transmission unit within a predefined rotational range, in particular by a monitoring unit of the transmission device, detection of a control position of a first and second transmission element within the rotational range, in particular by a detection unit of the transmission device, monitoring of the transmission unit based on a comparison of the controlled rotational position with the predefined rotational position when the control position is reached, in particular by the monitoring unit.

Thus, a method according to the invention has the same advantages as those already described in detail with reference to a transmission device according to the invention and/or a steering system according to the invention.

According to a further aspect of the invention, a computer program product is provided. The computer program product comprises instructions which, when executed by a control unit, cause the control unit to perform a method according to the invention.

Thus, a computer program product according to the invention has the same advantages as those already described in detail with reference to a transmission device according to the invention, a steering system according to the invention and/or a method according to the invention. This method may, in particular, be computer-implemented. The computer program product may be implemented as computer-readable instruction code. Furthermore, the computer program product may be stored on a computer-readable storage medium such as a data disk, a removable drive, a volatile or non-volatile memory, or a built-in memory/processor. Furthermore, the computer program product may be made available or provided in a network, such as the Internet, from which it can be downloaded or executed online by a user as required. The computer program product may be realized by means of software as well as by means of one or more special electronic circuits, i.e. in hardware or any hybrid form, i.e. by means of software components and hardware components.

### BRIEF DESCRIPTION OF THE DRAWINGS

The invention is explained in more detail below with reference to the attached drawings. In the figures:

FIG. 1 is a vehicle with a steering system according to an embodiment of the invention;

FIG. 2 is a transmission unit of the steering system in a control position;

FIG. 3 is the transmission unit of the steering system in a further position; and

FIG. 4 is a sequence of a method according to the invention for monitoring the transmission unit.

### DETAILED DESCRIPTION OF THE CURRENT EMBODIMENT

In the following description of several exemplary embodiments of the invention, identical reference numbers are used to designate the same technical features, even across different embodiment examples.

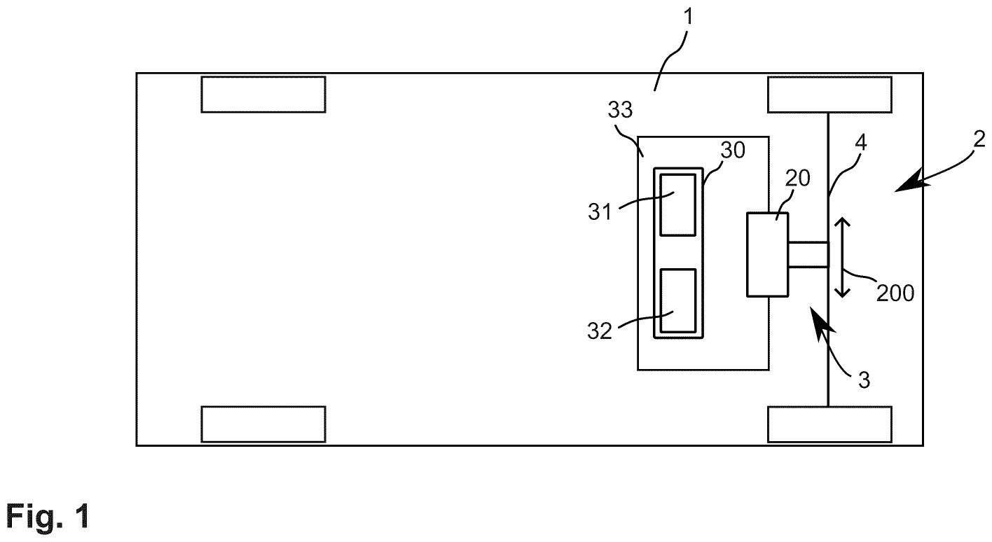

FIG. 1 shows a vehicle 1 with a steering system 2 according to the invention in a first exemplary embodiment. The steering system 2 comprises a transmission device 3 according to the invention for transmitting a drive movement for moving a steering rod 4 of the steering system 2.

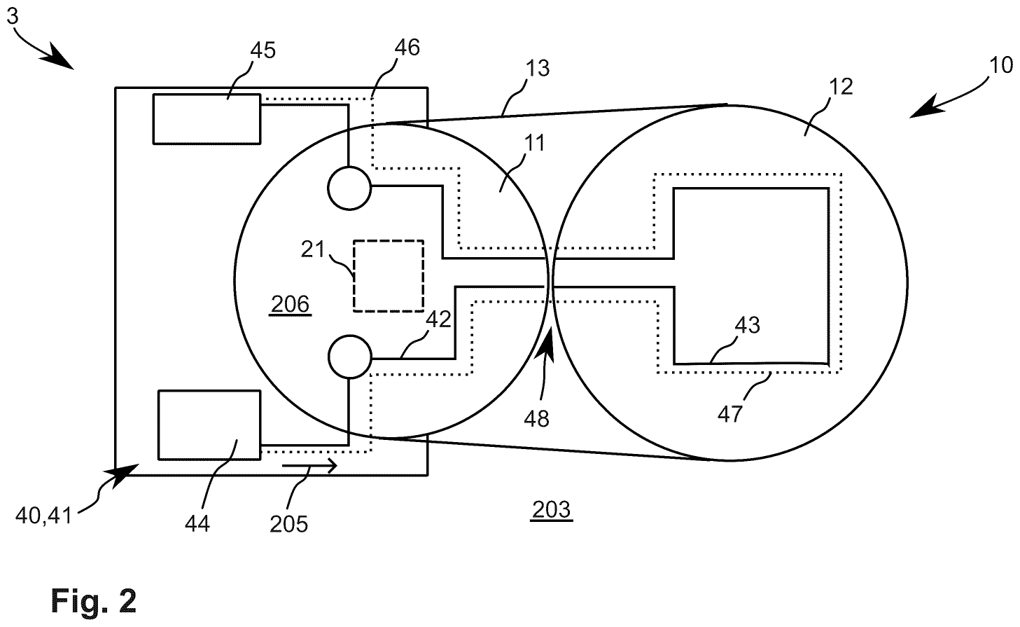

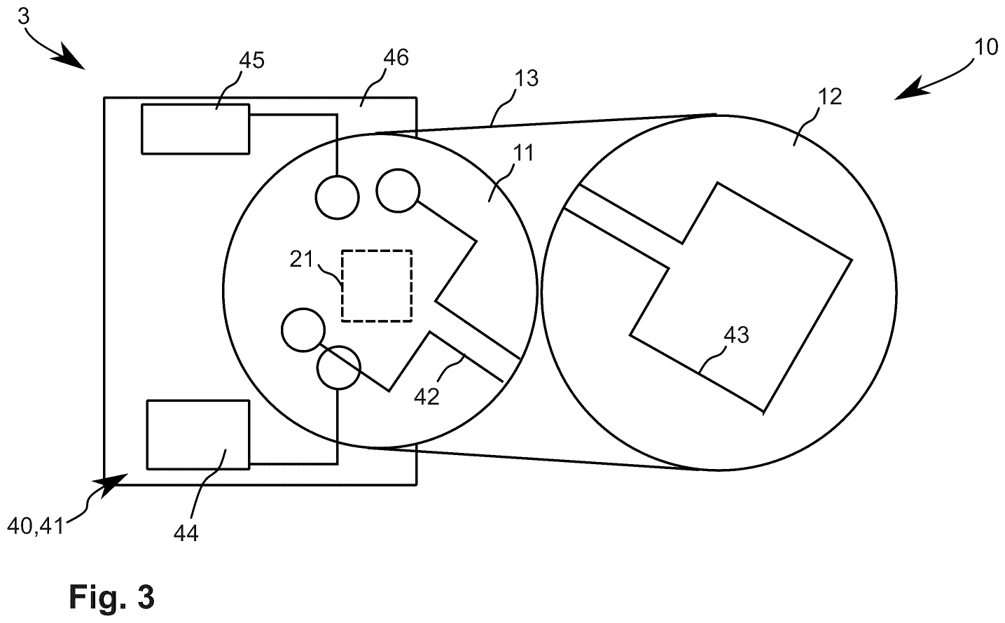

According to the first exemplary embodiment, the transmission device 3 is shown in FIGS. 2 and 3. The transmission device 3 comprises a drive 20 with a drive motor 21, which is integrated into the transmission device 3.

Furthermore, the transmission device 3 comprises a transmission unit 10 with a rotatable first gear element 11, which can be driven by the drive 20, and a rotatable second gear element 12, which is operatively connected to the first gear element 11 for transmitting a drive movement as a function of a transmission ratio between the first and second gear elements 11, 12. The transmission unit 10 forms a belt drive, in which the first and second gear elements 11, 12 each comprise a pulley and are connected by a belt 13. Furthermore, the first gear element 11 is designed to execute a first rotational position within a predefined rotational range 200, which is shown in FIG. 1 based on a linear movement of the steering rod 4, the limits of which define the rotational range 200. Furthermore, the second gear element 12 is designed to perform a second rotational position within the rotational range 200. The first and second rotational positions are coprime in order to enable an unambiguous relative positioning of the first and second gear elements 11 and 12.

Furthermore, the transmission device 3 comprises a detection device 40 for detecting at least one control position 203, as shown in FIG. 2, of the first and second gear elements 11, 12 for marking a predefined rotational position of the transmission unit 10 within the rotational range 200. The drive motor 21 is directly connected to the first gear element 11 in order to rotate the first gear element 11 at a motor speed of the drive motor 21. The detection device 40 is shown in FIGS. 2 and 3 and comprises a signal generating unit 41 for outputting a control signal 205 as a function of a physical interaction between the first and second gear elements 11, 12 in the control position 203. In the present exemplary embodiment, the interaction between the first and second gear elements 11, 12 in the control position 203 comprises an optical signal line. However, it is additionally or alternatively conceivable that the signal line is electrical, electromagnetic and/or sound-based.

For the optical signal line, the signal generating unit 41 has a first signal generating element 42 for rotation with the first gear element 11 and a second signal generating element 43 for rotation with the second gear element 12. The signal generating unit 41 is designed to output the control signal 205 as a function of the position of the first and second signal generating elements 42, 43 relative to one another.

For this purpose, the signal generating unit 41 comprises a signal source 44 and a signal receiver 45. The signal source 44 and the signal receiver 45 are arranged in a fixed position on a housing 46 of the transmission unit 10. The first signal transmitter element 42 may be coupled to the signal source 44 and the signal receiver 45 in a coupling position 206 within one revolution of the first transmission element 11, as shown in FIG. 2, and may be decoupled from the signal source 44 and the signal receiver 45 outside the coupling position 206, as shown in FIG. 3. As shown in FIG. 2, a signal path 47 may be formed by the first and second signal transmitter elements 42, 43, which is closed in the control position 203. To output the control signal 205 as an optical signal, the signal generating unit 41 comprises a light source. The first and second signal generating elements 42, 43 each comprise at least one optical waveguide for guiding the optical signal. The optical fibers each comprise two connection points 48, which may be aligned with each other in the control position 203 for transmitting the optical signal along the optical fibers.

Furthermore, the transmission device 3 comprises a monitoring unit 30 for monitoring the transmission unit 10 with a detection means 31 for detecting an actuated rotational position of the transmission unit 10 when transmitting the drive movement within the predefined rotational range 200. The monitoring unit 30 is designed to compare the controlled rotational position with the predefined rotational position when the control position 203 is reached, in order to monitor the transmission unit 10. This makes it possible to check whether the predefined rotation position in the control position 203 corresponds to the controlled rotation position. For intermediate storage of the controlled rotational position in a de-energized state of the transmission device 3, a monitoring unit 30 comprises a memory unit 32 for storing the controlled rotational position.

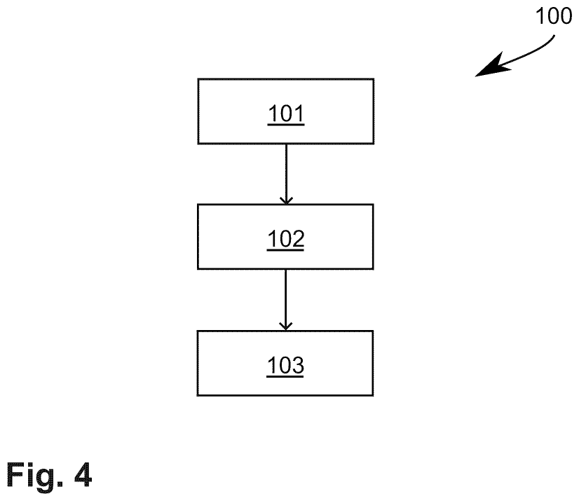

Thus, as shown in FIG. 4, a method 100 according to the invention for monitoring the transmission unit 10 may be carried out by the transmission device 3 by detecting 101 the actuated rotational position, detecting 102 the control position 203 and, based on this, monitoring 103 the transmission unit 10 by comparing the actuated rotational position with the predefined rotational position when the control position 203 is reached. Preferably, a computer program product is provided that includes instructions that, when executed by a control unit 33, cause the control unit 33 to execute the method 100. The detection device 40 and/or the monitoring unit 30 are preferably integrated into the control unit 33.

### LIST OF REFERENCE NUMBERS

1 vehicle
2 steering system
3 transmission device
4 steering rod
11 first gear element
12 second gear element
10 transmission unit
100 method
13 belt
20 drive
21 drive motor
30 monitoring unit
31 detection means
32 memory unit
33 control unit
40 detection device
41 signal generating unit
42 first signal generating element
43 second signal generating element
44 signal source
45 signal receiver
46 housing
47 signal path
48 connection points
100 method
101 detection
102 detect
103 monitor
200 rotational range
203 control position
205 control signal
206 coupling position

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A transmission device for a steering system, comprising:
a transmission unit having a rotatable first gear element, which may be driven by a drive, and a rotatable second gear element, which is operatively connected to the first gear element for transmitting a drive movement as a function of a transmission ratio between the first and second gear elements,
a monitoring unit for monitoring of the transmission unit configured to detect a controlled rotational position of the transmission unit when transmitting the drive movement in a predefined rotational range, and
a detection device for detecting at least one control position of the first and second gear elements for marking a predefined rotational position of the transmission unit within the rotational range,
wherein the monitoring unit is configured to compare the controlled rotational position with the predefined rotational position when the control position is reached, to monitor the transmission unit.

2. The transmission device according to claim 1,
wherein the first gear element is configured to execute a first rotational position within the rotational range, and the second gear element is configured to execute a second rotational position within the rotational range, the first and second rotational positions being relatively prime.

3. The transmission device according to claim 1,
wherein the transmission unit forms a belt drive, wherein the first and second gear elements are each formed by a pulley and connected by a belt.

4. The transmission device according to claim 1,
wherein the detection device has a signal generating unit for outputting a control signal as a function of a physical interaction of the first and second gear elements in the control position.

5. The transmission device according to claim 1,
wherein the interaction of the first and second gear elements in the control position comprises an electrical, electromagnetic, optical, or sound-based signal line.

6. The transmission device according to claim 1,
wherein the signal generating unit has a first signal generating element for rotation with the first gear element and a second signal generating element for rotation with the second gear element, the signal generating unit being configured to output the control signal as a function of a position of the first and second signal generating elements relative to one another.

7. The transmission device according to claim 1,
wherein the signal generating unit has a signal source and a signal receiver, the signal source and the signal receiver being arranged in a stationary manner on a housing of the transmission unit, wherein the first signal generating element is couplable to the signal source and the signal receiver in a coupling position within one revolution of the first gear element and is decouplable from the signal source and the signal receiver outside the coupling position.

8. The transmission device according to claim 1,
wherein a signal path is formed by the first and second signal generating elements, whose signal path is closed in the control position.

9. The transmission device according to claim 1,
wherein the signal generating unit has a light source for emitting the control signal as an optical signal.

10. The transmission device according to claim 1,
wherein the first and second signal generating elements each have at least one optical waveguide for guiding the optical signal, the optical waveguides each having two connection points which are alignable with respect to one another in the control position for transmitting the optical signal along the optical waveguides.

11. The transmission device according to claim 1,
wherein a drive motor of the drive is integrated into the transmission device, the drive motor being directly connected to the first gear element in order to rotate the first gear element at a motor speed of the drive motor.

12. The transmission device according to claim 1,
wherein the monitoring unit has a memory unit for temporarily storing the controlled rotational position in a de-energized state of the transmission device.

13. A steering system or a vehicle comprising
a transmission device according to claim 1.

14. A method for monitoring a transmission unit of a transmission device according to claim 1, comprising:
detecting of a controlled rotational position of the transmission unit in a predefined rotational range,
detecting of a control position of a first and second gear element within the rotational range,
monitoring of the transmission unit on the basis of a comparison of the controlled rotational position with the predefined rotational position when the control position is reached.

15. A computer program product comprising instructions which, when executed by a control unit, cause the control unit to perform a method according to claim 14.
